(19) United States
(12) Patent Application Publication
(10) Pub. No.: US 2021/0248706 A1
(43) Pub. Date: Aug. 12, 2021

(54) PERSONALIZED WAGERING ON LIVE EVENTS

(71) Applicant: AdrenalineIP, Washington, DC (US)

(72) Inventors: Casey Alexander HUKE, Washington, DC (US); John CRONIN, Jericho, VT (US); Joseph BODKIN, Quincy, MA (US); Harrison GRANT, Anaheim, CA (US)

(73) Assignee: AdrenalineIP, Washington, DC (US)

(21) Appl. No.: 17/082,179

(22) Filed: Oct. 28, 2020

Related U.S. Application Data
(60) Provisional application No. 62/972,127, filed on Feb. 10, 2020.

(51) Int. Cl. G06Q 50/34; G07F 17/32

(52) U.S. Cl. CPC G06Q 50/34; G07F 17/323; G07F 17/3288; G07F 17/3237; G07F 17/3244

(57) ABSTRACT

An embodiment may include a software system designed for sports analytics and data management with respect to wagering on events in real time, where the software system is capable of assessing a user's level of sports or sport knowledge by a series of algorithms dependent on user data, such as frequency of placing a wager, sports wagered on, teams wagered on, amount of money wagered. For example if the user is consistently placing wagers and then does not place a wager for 2+ months, the algorithms can lower the users experience levels since they have not been actively wagering for a long period of time and are not as experienced as they were 2+ months ago.

### CROSS-REFERENCE TO RELATED APPLICATIONS

The present patent application claims benefit and priority to U.S. Provisional Patent Application No. 62/972,127 entitled “SYSTEM FOR USER EXPERIENCE BASED ODDS ADJUSTMENT” filed on Feb. 10, 2020 which is hereby incorporated by reference into the present disclosure.

### FIELD OF THE DISCLOSURE

An exemplary embodiment is generally related to sports betting and smart phone applications.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Experienced bettors will more often be able to win their bets because they are more knowledgeable about the specific game or event they are betting on. This means that if the odds are completely fair based on random chance, experienced bettors can end up costing the bet offeror money.

The obvious solution would be to lower the bet odds so that the bet offeror doesn't lose any money, but this means that low experience and new bettors suffer from artificially lowered odds because of the experienced bettors. This can drive away new clientele and could be considered unfair to casual bettors.

Traditionally it has been very difficult to target bettors as individuals because the bet offeror would have to show everyone the same odds.

### SUMMARY

A method for adjusting odds of a sports betting game. The method may include the steps of: identifying an event and associated potential outcomes, identifying micro-events with more than one potential outcomes within the event, presenting betting options and odds to a user or bettor based on the potential outcomes of the micro-event, adjusting the odds presented to the user based on the user's past betting behavior, receiving a bet wagered on at least one betting option, and crediting the user if the user wins the bet.

An exemplary embodiment includes a method of cultivating and storing user profiles based on a user's betting trends and demographic information and predicting rewards accordingly through the use of artificial intelligence (AI), where the user places bets through a proprietary data management and analytic software system/wagering platform. For example, the AI may suggest that a twenty-one-year-old male user who just won a large wager also receives a reward of a beer coupon. An embodiment may include a set of proprietary algorithms used to assess betting odds of users of different experience levels (i.e., an algorithm for beginner users and an algorithm for experienced users), where the users are subscribers of a proprietary data management and analytic software system/wagering platform. In this embodiment, the algorithms vary depending on the experience level of the user.

An exemplary embodiment further includes a proprietary method of creating custom odds for individuals based upon a person's respective betting history, where bets were made via a proprietary data management and analytic software system/wagering platform. An embodiment includes a method of extracting and incorporating user feedback into a data management and analytic software system/wagering platform in order to create and improve upon specific odds which may then be sent as notifications to the user as wagers of potential interest. An embodiment includes a method of assessing a user's betting history to predict a user's future behavior with respect to future wagers or purchases made through advertisements, where the user is a subscriber of a proprietary data management and analytic software system/wagering platform. An embodiment includes a method of providing the results of sports wagers made by specific users of a sports analysis and betting platform to those users, including the user's in-game history (right vs. wrong), the winners of previous drives/quarters, the amount of points or money the user has won, the occurrence of a significant play, such as a touchdown, etc.

### BRIEF DESCRIPTIONS OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a micro-event individualized odds adjuster, according to an embodiment.

FIG. 2 illustrates a server base module, according to an embodiment.

FIG. 3 illustrates a bet options module, according to an embodiment.

FIG. 4 illustrates a bet database, according to an embodiment.

FIG. 5 illustrates a user odds adjuster module, according to an embodiment.

FIG. 6 illustrates a base module, according to an embodiment.

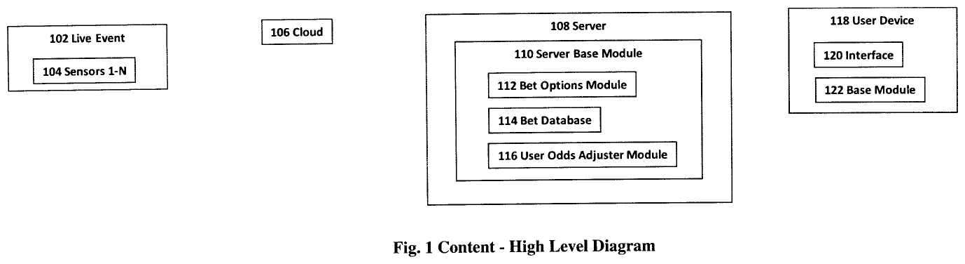

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention

As used herein, the word exemplary means serving as an example, instance or illustration. The embodiments described herein are not limiting, but rather are exemplary only. It should be understood that the described embodiments are not necessarily to be construed as preferred or advantageous over other embodiments. Moreover, the terms embodiments of the invention, embodiments or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, hit, performed by a participant in a sporting event. In some embodiments, an action may be a strategic decision made by a participant in the sporting event such as a player, coach, management, etc. In some embodiments, an action may be a penalty, foul, or type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity on the basis of the outcome of a future event, such as the results of a game or event. It may be understood that non-monetary items may be the subject of a “bet” or “wager” as well, such as points or anything else that can be quantified for a “wager” or “bet.” A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be done for certain amount or for a future time. A “bet” or “wager” can be done for being able to answer a question correctly. A “bet” or “wager” can be done within a certain period of time. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain for the purpose of placing bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sports book has reduced its betting limits, usually because of weather or the uncertain status of injured players is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides”, “favorite”, “chalk”, “circled game”, “laying the points price”, “dog” and “underdog” can be integrated into the embodiments in a variety of manners.

The “money line” refers to the odds expressed in terms of money. With money odds, whenever there is a minus (−) the player “lays” or is “laying” that amount to win (for example $100); where there is a plus (+) the player wins that amount for every $100 wagered. A “straight bet” refers to an individual wager on a game or event that will be determined by a point spread or money line. The term “straight-up” means winning the game without any regard to the “point spread”; a “money-line” bet. “Money line”, “straight bet”, “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread”. A handicap of the “point spread” value is given to the favorite team so bettors can choose sides at equal odds. “Cover the spread” means that a favorite win an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread”. The “opening line” means the earliest line posted for a particular sporting event or game. The term “pick” or “pick 'em” refers to a game when neither team is favored in an event or game. “Line”, “cover the spread”, “cover”, “tie”, “pick” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules, in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. Event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total”, “over”, and “under” can be integrated into the embodiments in a variety of manners.

A “parlay” is a single bet that links together two or more wagers; to win the bet, the player must win all the wagers in the “parlay”. If the player loses one wager, the player loses the entire bet. However, if he wins all the wagers in the “parlay”, the player wins a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay”, “round robin”, “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events, typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both of the pitchers scheduled to start a game actually start. If they don't, the bet is deemed “no action” and refunded. The “run line” in baseball, refers to a spread used instead of the money line. “Listed pitchers” and “no action” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle”, “juice”, vigorish”, “vig” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individual that would deploy, for fees, and may be part of, of perform, various system elements or method steps in the embodiments.

Managed service user interface service is a service that can help customers (1) manage third parties, (2) develop the web, (3) do data analytics, (4) connect thru application program interfaces and (4) track and report on player behaviors. A managed service user interface can be integrated into the embodiments in a variety of manners.

Managed service risk management services are a service that assists customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling and (4) customer service assistance. These managed service compliance services can be integrated into the embodiments in a variety of manners.

Managed service pricing and trading service is a service that helps customers with (1) official data feeds, (2) data visualization and (3) land based, on property digital signage. These managed service pricing and trading services can be integrated into the embodiments in a variety of manners.

Managed service and technology platform are services that helps customers with (1) web hosting, (2) IT support and (3) player account platform support. These managed service and technology platform services can be integrated into the embodiments in a variety of manners.

Managed service and marketing support services are services that help customers (1) acquire and retain clients and users, (2) provide for bonusing options and (3) develop press release content generation. These managed service and marketing support services can be integrated into the embodiments in a variety of manners.

Payment processing services are those services that help customers that allow for (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat your players to free bets, odds boosts, enhanced access and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by managing commission and availability at all times. The “cash out” or “pay out” or “payout” can be integrated into the embodiments in a variety of manners, including both monetary and non-monetary payouts, such as points, prizes, promotional or discount codes, and the like.

“Customized betting” allow customers to have tailored personalized betting experiences with sophisticated tracking and analysis of players' behavior. “Customized betting” can be integrated into the embodiments in a variety of manners.

Kiosks are devices that offer interactions with customers clients and users with a wide range of modular solutions for both retail and online sports gaming. Kiosks can be integrated into the embodiments in a variety of manners.

Business Applications are an integrated suite of tools for customers to manage the everyday activities that drive sales, profit, and growth, from creating and delivering actionable insights on performance to help customers to manage the sports gaming. Business Applications can be integrated into the embodiments in a variety of manners.

State based integration allows for a given sports gambling game to be modified by states in the United States or countries, based upon the state the player is in, based upon mobile phone or other geolocation identification means. State based integration can be integrated into the embodiments in a variety of manners.

Game Configurator allow for configuration of customer operators to have the opportunity to apply various chosen or newly created business rules on the game as well as to parametrize risk management. Game configurator can be integrated into the embodiments in a variety of manners.

“Fantasy sports connector” are software connectors between method steps or system elements in the embodiments that can integrate fantasy sports. Fantasy sports allow a competition in which participants select imaginary teams from among the players in a league and score points according to the actual performance of their players. For example, if a player in a fantasy sports is playing at a given real time sports, odds could be changed in the real time sports for that player.

Software as a service (or SaaS) is a method of software delivery and licensing in which software is accessed online via a subscription, rather than bought and installed on individual computers. Software as a service can be integrated into the embodiments in a variety of manners.

Synchronization of screens means synchronizing bets and results between devices, such as TV and mobile, PC and wearables. Synchronization of screens can be integrated into the embodiments in a variety of manners.

Automatic content recognition (ACR) is an identification technology to recognize content played on a media device or present in a media file. Devices containing ACR support enable users to quickly obtain additional information about the content they see without any user-based input or search efforts. To start the recognition, a short media clip (audio, video, or both) is selected. This clip could be selected from within a media file or recorded by a device. Through algorithms such as fingerprinting, information from the actual perceptual content is taken and compared to a database of reference fingerprints, each reference fingerprint corresponding to a known recorded work. A database may contain metadata about the work and associated information, including complementary media. If the fingerprint of the media clip is matched, the identification software returns the corresponding metadata to the client application. For example, during an in-play sports game a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet” which is a computer-generated data point is placed above the player that is bet on. Augmented reality can be integrated into the embodiments in a variety of manners.

Some embodiments of this disclosure, illustrating all its features, will now be discussed in detail. It can be understood that the embodiments are intended to be open ended in that an item or items used in the embodiments is not meant to be an exhaustive listing of such item or items, or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

This is a system for a micro-event individualized odds adjuster. This system includes a live event 102, for example a sporting event such as a football game, basketball game, baseball game, hockey game, tennis match, golf tournament, etc. The live event 102 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 102, such as the score of American football or the run line in baseball, or a series of action in the live event 102. Sportsbooks have an amount of bets they can handle, a limit of wagers they can take on either side of a bet before they will move the line or odds off of the opening line. Additionally, there are circumstances, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live events in the future. Sportsbooks need to offer payment processing services in order to cash out customers. This can be done at kiosks at the live event or at another location. The system may include a plurality of sensors 104 that may be used such as motion sensors, temperature sensors, humidity sensors, cameras such as an RGB-D Camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors 104 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball. The system also includes a cloud 106 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance. The cloud 106 may be communicatively coupled to server 108 which may perform real time analysis on the type of play and the result of the play. The cloud 106 may also be synchronized with game situational data, such as the time of the game, the score, location on the field, weather conditions, and the like which may affect the choice of play utilized. For example, in other exemplary embodiments, the cloud 106 may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. The system may include a server 108 which may perform real time analysis on the type of play and the result of a play or action. The server 108 (or cloud 106) may also be synchronized with game situational data, such as the time of the game, the score, location on the field, weather conditions, and the like which may affect the choice of play utilized. For example, in other exemplary embodiments, server 108 may not receive data gathered from sensors and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein. The server 108 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user. A server base module 110 receives data from the live event 102 and feeds that data into the bet options module 112. A bet options module 112 determines the possible next micro-events from the information from the live event 102 and determines the odds of each micro-event occurring. A bet database 114 stores the user's bet selection, wager amount, and if the bet was won, lost, or is still pending. A user odds adjuster module 116 adjusts the odds for an individual user based on that user's betting history and experience level. A user device 118 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provide for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The user device 118 can leverage the sensors in for purposes such as automatic content recognition, augmented reality or the synchronization of screens between the user device interface 120 and other displays. The interface(s) 120 may either accept inputs from users or provide outputs to the users or may perform both the actions. In one case, a user can interact with the interface(s) 120 using one or more user-interactive objects and devices. The user-interactive objects and devices may include user input buttons, switches, knobs, levers, keys, trackballs, touchpads, cameras, microphones, motion sensors, heat sensors, inertial sensors, touch sensors, or a combination of the above. Further, the interface(s) 120 may either be implemented as a Command Line Interface (CLI), a Graphical User Interface (GUI), a voice interface, or a web-based user-interface. A base module 122 displays the betting options to the user and records the user's bet selections.

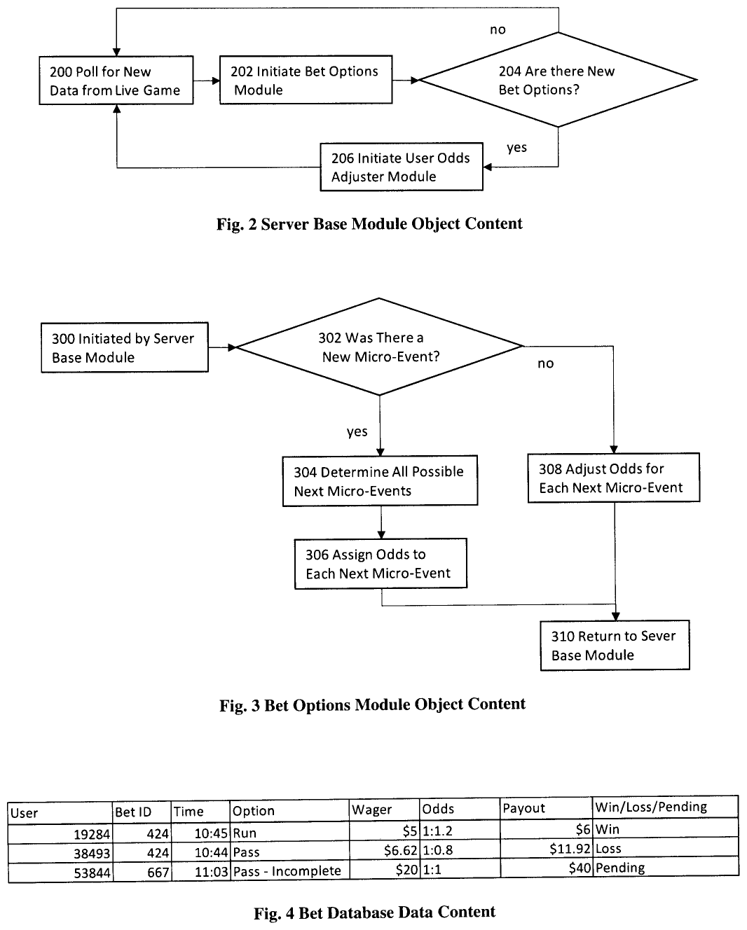

Functioning of the server base module 110 will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the server base module 110. The process begins with the server base module 110 polling the live game for new data at step 200. The server base module 110 initiates the bet options module 112 when there is new data from the live game and passes in that data, at step 202. The server base module 110 determines if there are new bet options from the bet options module 112; if there are no bet options or the bet options did not change, the server base module 110 continues to poll for new data, at step 204. If there are new bet options, the server base module 110 initiates the user odds adjuster module 116 and passes in those bet options, at step 206.

Functioning of the bet options module 112 will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the bet options module 112. The process begins with the bet options module 112 being initiated by the server base module 110 which passes in new data from the live event 102, which may be in the form of sensory data from sensors, or event data, for example, 1st down, 2nd inning, 3rd quarter, at step 300. The bet options module 112 determines if the data from the live game indicates that there is a new micro-event, for example if the down has changed, there is a new batter, possession of the ball has changed, this may be determined by a direct signal from the live game that a change has happened, or by the bet options module 112 comparing the current data against some historical database, in some embodiments the bet options module 112 may temporarily store data on at least one previous micro-event, at step 302. If the data from the live game indicates there is a new micro-event, the bet options module 112 determines all possible micro events that could occur next based on the rules of the game, for example, if the current play is second down and there was no interception, the possible micro-events for third down may be: pass, run, punt, pass (incomplete), timeout call, etc. In some embodiments the next micro-events might only be limited to a few options, at step 304. The bet options module 112 assigns odds to each next micro-event, these odds may be based on a default value, based on historical data, based on current data from the live game, based on what users are betting on, based on any other method of determining odds for a wager, or based on any combination of methods, at step 306. If the data from the live game indicates there is no new micro-event, the bet options module 112 adjusts the odds based on the new data, for example if the sensory data from the live game indicates a change in wind speed, the odds of a pass may be reduced because historically coaches or players may avoid making passes into high winds, at step 308. The bet options module 112 returns the bet options to the server base module 110, at step 310.

Functioning of the bet database 114 will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the bet database 114. The bet database 114 contains the user's bet selection, wager amount, if the bet was won, lost, or is still pending, and any other metrics that may be useful to determine user behavior and experience level, which could be determined to be sport or sports knowledge or sport or sports betting knowledge. For example, “win streak” might be a data point that records a user's consecutive wins. Some data may be calculated by other modules.

Functioning of the user odds adjuster module 116 will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the user odds adjuster module 116. The process begins with the user odds adjuster module 116 being initiated by the server base module 110 which also passes in new bet options. New bet options may refer to entirely new options, or options who's associated odds have been adjusted based on live data, at step 500. The user odds adjuster module 116 selects a first user, that first user is any user whose odds have not already been adjusted. In an exemplary embodiment, active users would receive priority over inactive users, at step 502. The user odds adjuster module 116 retrieves all bets the user has made from the bet database 114, at step 504. The user odds adjuster module 116 determines the user's experience level or sport/sports knowledge using data from their betting behavior; for example, users with more wins than losses will have a higher experience level than users with more losses than wins, users with bets over a longer period of time may have more experience than new users, and users who bet frequently may have more experience than infrequent users. Experience may be based on any or all betting metrics, experience may be tied to bets on a specific sport, team, type of play, etc. In an embodiment, artificial intelligence may be used to determine the optimal parameters for measuring user experience, in another embodiment experience level would be stored in a separate database and the saved value could be used if there have been no changes. In a specific, non-limiting example, users are assigned a football expertise score including points, each win of a football-based bet awards the user 3 points, and each loss removes 2 points. After a week without any bets on a football game the user loses 1 point per day, at an example of step 506. The user odds adjuster module 116 adjusts the odds of each bet option based on the user's experience level. In an embodiment, users may be bracketed into categories based on experience level such as novice, intermediate, and expert, and each category may have a direct modifier for odds such as 5%, 10%, and 15% respectively. In another embodiment experience may be a gradient and odds may be adjusted on a spectrum, for example, the least experienced player may have 0% adjustment but the adjustment increases as a function of experience up to 20% for the most experienced user. In a specific, non-limiting example, users are assigned a football expertise score including points, a score of 100 or less indicates the user is a novice and receives no adjustment to their odds, users between 100 and 1,000 points are intermediate users and odds are adjusted by 5%, users with a score between 1,000 and 10,000 points are experts and odds are adjusted by 10%. Users above 10,000 points are grandmasters and are given a leaderboard rank based on their football expertise score, the bottom 20%, or first quintile, of grandmasters have their odds adjusted by 11%, the 2nd quintile of grandmasters have their odds adjusted by 12%, the 3rd quintile of grandmasters have their odds adjusted by 13%, the 4th quintile of grandmasters have their odds adjusted by 14%, and the top 20% of users ranked by football expertise score have their odds adjusted by 15%. In each case the original odds in the bet database 114 would be multiplied by the corresponding adjustment before being sent to the user device 118, at step 508. The user odds adjuster module 116 sends the bet options and adjusted odds to the user device 118. In another embodiment, the bet options and adjusted odds are stored in a database until the user device 118 requests that information. In another embodiment the user odds adjustment module sends only the adjusted odds and the bet options are sent by another module. In another embodiment the user odds adjustment module sends only the adjustment and the original odds are sent by another module, at step 510. The user odds adjuster module 116 determines if there is another user for which adjusted odds have not been calculated. If it is determined there is another user for which adjusted odds have not been calculated, the user odds adjuster module 116 returns to step 502, at step 512. If there are no other users, the user odds adjuster module 116 returns to the server base module 110, at step 514.

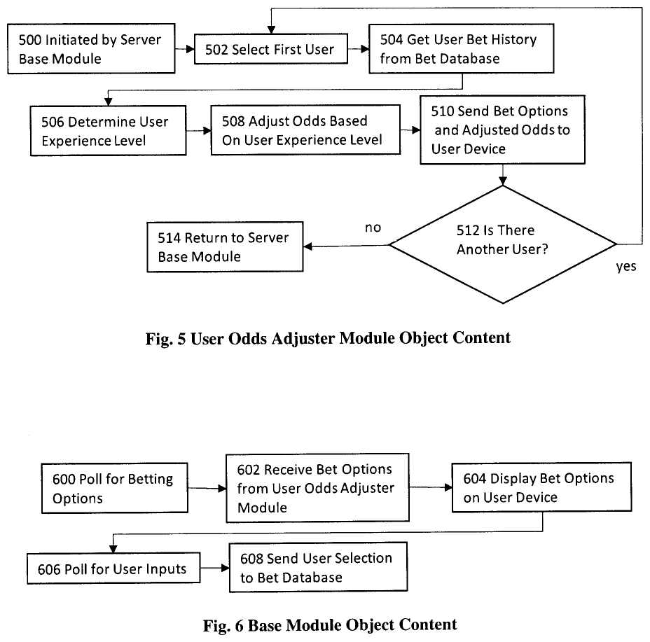

Functioning of the base module 122 will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the base module 122. The process begins with the base module 122 polling the bet options module 112 on the server. In some embodiments if there are no bet options available the base module 122 will display a message to indicate to the user that they cannot bet, for example, “betting currently closed”, “waiting on new play data”, or “event ended”, at step 600. The base module 122 receives bet options and odds from the user odds adjuster module 116 on the server 108, at step 602. The base module 122 displays the bet options and associated odds to the user and prompts the user for their bet selection and wager amount, at step 604. The base module 122 polls for the user's bet selection and wager amount before continuing, at step 606. The base module 122 sends the user's bet selection and wager amount to the bet database 114 on the server 108, at step 608.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A method for sports game betting using a determined level of sport or sports knowledge comprising:
identifying an event with more than one potential outcome at a conclusion of the event;
identifying a micro-event within the event, the micro event having more than one potential outcome at its conclusion but not dependent on the conclusion of the event;
presenting betting options and odds to through a graphical user interface based on the more than one potential outcome of the micro event; and
adjusting the odds based on a betting behavior corresponding to the bettor by identifying one or more patterns in the user betting history.

2. The method of claim 1, wherein the step of adjusting the odds further includes identifying a historical win-loss ratio associated with the user.

3. (canceled)

4. The method of claim 1, wherein the identified patterns are one of a win streak and a lose streak.

5. The method of claim 1, further comprising: receiving a bet wagered on at least one betting option presented through the graphical user interface; and paying the bet, after the conclusion of the micro event, if the bet is successful.

6. A method for adjusting odds of a wager, comprising:
selecting a user;
identifying a user bet history from a bet database corresponding to the user;
determining a user experience level based on the user bet history;
adjusting the odds of one or more wagers presented to the user based on the user experience level and one or more patterns in the user betting history; and
displaying the wagers and adjusted odds on a user device.

7. The method of claim 6, further comprising identifying a plurality of micro-events corresponding to one or more events, wherein the wagers correspond to a plurality of potential outcomes corresponding to the micro-events.

8. The method of claim 7, wherein the step of identifying a plurality of micro-events comprises polling for new data from a live event.

9. The method of claim 6, further comprising assigning an expertise score to the user, wherein the expertise score is adjusted based on the outcome of a bet.

10. The method of claim 6, wherein the user experience level is specific to a sport.

11. The method of claim 6, wherein the user experience level is specific to a team or a type of play.

12. The method of claim 6, further comprising placing the user into a category based on the user experience level.

13. The method of claim 11, wherein the odds are adjusted based on the category corresponding to the user.
